(19) United States
(12) Patent Application Publication
(10) Pub. No.: US 2001/0049728 A1
(43) Pub. Date: Dec. 6, 2001

(54) Electronic music distribution service system and method using synchronous multimedia integration language format

(76) Inventor: Dong-seok Kang, Yongin-city (KR)

Correspondence Address: STAAS & HALSEY LLP, 700 11TH STREET, NW, SUITE 500, WASHINGTON, DC, 20001, US

(21) Appl. No.: 09/790,726

(22) Filed: Feb. 23, 2001

(30) Foreign Application Priority Data
May 9, 2000 (KR) 00-24613

(51) Int. Cl. G06F 15/16

(52) U.S. Cl. 709/219

(57) ABSTRACT

An electronic music distribution (EMD) service system and method using a synchronous multimedia integration language (SMIL) format under a network environment, the system including a web server to upload a multimedia file, which is generated using a synchronous multimedia integration language (SMIL) format, from the web browser of a user terminal linked to the network, to generate a hyper text markup language (HTML) corresponding to the multimedia file, and to display the HTML file so that a user can access the HTML file through a web browser; a file database to store the uploaded multimedia file and the corresponding HTML file; and a streaming server to search the file database for a multimedia file requested by the web browser linked to the web page and to provide the multimedia file in a streaming service.

### CROSS-REFERENCE TO RELATED APPLICATIONS

This application claims the benefit of Korean Application No. 00-24613, filed May 9, 2000, in the Korean Industrial Property Office, the disclosure of which is incorporated herein by reference.

### BACKGROUND OF THE INVENTION

1. Field of the Invention

The present invention relates to an electronic music distribution (EMD) service, and more particularly, to an EMD service system using synchronous multimedia integration language (SMIL) format, and a method therefor.

2. Description of the Related Art

These days, a multimedia player simultaneously reproducing audio, image and text files is widely used. The multimedia player can operate after being installed in a computer having a sound card, a graphic card, and an application program for reproducing multimedia files. Also, the multimedia player can be implemented in the form of a multimedia apparatus for reproducing only multimedia files. By executing a desired multimedia file through a computer or a multimedia apparatus, a user can view images and texts while listening to audio sound.

In line with the development of multimedia technologies, in addition to the multimedia player, which simply reproduces an already authored multimedia file, an authoring tool, which enables a user to directly author a multimedia file, is required. In addition, the existing EMD services provided through computer communication networks only allow music or music video to be downloaded or streamed. However, simply downloading music cannot satisfy the demand of users in the midst of these multimedia developments, and music video, due to its huge size, is not appropriate to download in all circumstances.

### SUMMARY OF THE INVENTION

To solve the above problems, it is an object of the present invention to provide an electronic music distribution (EMD) service system using a synchronous multimedia integration language (SMIL) format, in which an SMIL file generated in a user terminal is uploaded through a network and the uploaded SMIL file is provided to a user, who wants the file, in a streaming service so that the SMIL file directly authored by the user can be easily shown to other users.

It is another object to provide a multimedia file service method in an EMD service system in which an SMIL file generated in a user terminal is uploaded through a network and displayed in the form of a web page.

It is another object to provide a streaming service method in an EMD service system in which a multimedia file generated using an SMIL file is provided to those users who want the file in a streaming service.

It is another object to provide a mail service method in an EMD service system in which a multimedia file generated using an SMIL file is provided to the users who want the multimedia file in an E-mail service.

Additional objects and advantages of the invention will be set forth in part in the description which follows and, in part, will be obvious from the description, or may be learned by practice of the invention.

To accomplish the above and other objects of the present invention, an embodiment of the present invention provides an electronic music distribution (EMD) service system in a network environment having a web server to upload a multimedia file, which is generated using a synchronous multimedia integration language (SMIL) format, from a web browser of a user terminal linked to the network, to generate a hyper text markup language (HTML) file corresponding to the multimedia file, and to display the HTML file so that another user can access the HTML file through another web browser; a file database to store the uploaded multimedia file and the corresponding HTML file; and a streaming server to search the file database for a multimedia file requested by the web browser linked to the web page and to provide the multimedia file in a streaming service.

According to a further embodiment of the present invention, a multimedia file service method in an electronic music distribution (EMD) service system includes uploading a multimedia file, which is generated in a user terminal using a synchronous multimedia integration language (SMIL) format, from a web browser of the user terminal; generating a hyper text markup language (HTML) file corresponding to the uploaded multimedia file, and storing the HTML file in a file database; and displaying the files stored in the file database in the form of a web page so that the same and/or another user can access the files through the same and/or another web browser.

According to still another embodiment of the present invention, there is provided a streaming service method in an electronic music distribution (EMD) system for a multimedia file generated using a synchronous multimedia integration language (SMIL) format, the streaming service method including displaying file information in the form of a web page, referring to a file database which stores the multimedia file and the corresponding hyper text markup language (HTML) files; determining whether a user accesses the HTML file on the web page through the web browser and selects to play a desired multimedia file; and when the user selects to play the desired multimedia file, searching the file database and providing the corresponding multimedia file in a streaming service.

According to a yet further embodiment of the present invention, an electronic message service method in an electronic music distribution (EMD) system for a multimedia file generated using a synchronous multimedia integration language (SMIL) format includes displaying file information in the form of a web page, referring to a file database storing the multimedia file and the corresponding hyper text markup language (HTML) file; determining whether a user accesses the HTML file on the web page through the web browser and selects to send an electronic message of the desired multimedia file; and when the user wants to send the electronic message, sending an electronic message to a location designated by the user, after attaching the corresponding HTML file.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram showing an electronic music distribution (EMD) service system using a synchronous multimedia integration language (SMIL) format according to an embodiment of the present invention;

FIG. 2 is a flowchart showing an EMD service method according to an embodiment of the present invention; and

FIG. 3 shows an example of web pages included in a web site providing an EMD service according to an embodiment of the present invention.

### DESCRIPTION OF THE PREFERRED EMBODIMENTS

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

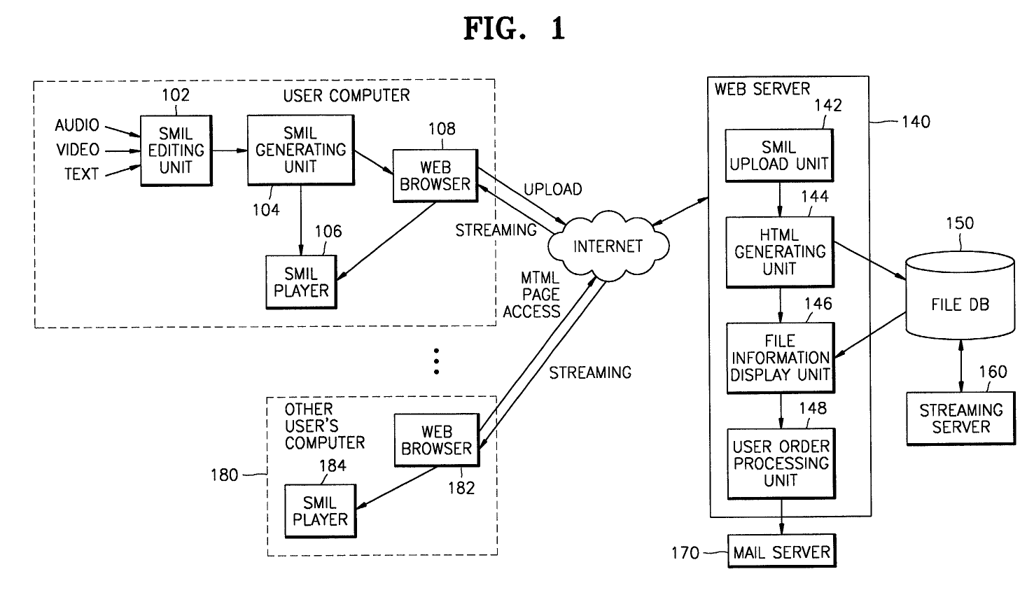

FIG. 1 is a block diagram showing an electronic music distribution (EMD) service system using a synchronous multimedia integration language (SMIL) format according to an embodiment of the present invention. The web site for an EMD service includes a web server 140, a file database (DB) 150, a streaming server 160, and a mail server 170. As shown, the web server 140 includes an SMIL upload unit 142, a hypertext markup language (HTML) generating unit 144, a file information display unit 146, and a user order processing unit 148.

In general, the EMD service according to the shown embodiment of the present invention is a service which is supported by a web server under a web-based environment in which a plurality of user computers 100˜180 and the web server 140 of a site operator are connected through a communication network, preferably through the internet 120. A user computer 100 has a web browser 108, which is connected to the web server 140 through the internet 120, and the web server 140 sends web pages already prepared through the internet 120 in response to a request of the web browser 108.

As shown, the web server 140 is a computer, either a special purpose or general purpose computer, in which a server software program is installed and which can respond to the request of a web client such as the web browser 108. The web browser 108 refers to a software program that can read a web page, that is, an HTML document, which is a standard web document, and communicate with a web server, using a common gateway interface (CGI). However, it is understood that the web browser 108 is also used to indicate a computer executing the software. Also, the various databases (DBs), such as a file DB 150 in the shown embodiment of the present invention, to which the web server 140 refers are recording media, such as hard discs, in which related data are systematically stored to allow the easy addition, updating, and retrieval of files. A database (DB) is also used to indicate both a recording medium and data stored therein.

The SMIL applied to the present invention is a multimedia layout language proposed by World Wide Web Consortium (W3C), and an extensible markup language (XML), which is a web document format. The SMIL integrates multimedia information including text, audio, drawings, and moving pictures, and enables the synchronization of this information. Since only text files and image files are added to the original music file in an SMIL file, the size is raised to only 1 or 2 megabits over an MP3 file, and a service of contents similar to a music video can be provided.

An EMD service system according to an embodiment of the present invention receives an uploaded SMIL-format multimedia file, which is generated in the user computer 100, and provides the file to the computers of arbitrary users who want the file, in a streaming service.

Referring to FIG. 1, a multimedia file is generated using an SMIL format in an arbitrary user computer 100. An SMIL editing unit 102 loads a selected graphic file, audio file and text file on a file location designated by the user, and then, reproduces the audio file and at the same time reproduces the graphic file and the text file, respectively, tuned to the reproduction synchronization of the audio file. An SMIL generating unit 104 generates the SMIL file using the SMIL format, by combining the reproduced files. An SMIL player 106 plays the generated SMIL file. As shown, the SMIL player 106 has not only a function for playing the SMIL file itself, but also a support function for a streaming service, which will be further explained below.

Meanwhile, the web browser 108 accesses a web site for an EMD service through the internet 120 at the request of the user, and requests to upload the SMIL file generated through the SMIL generating unit 104. In response to the request, the web server 140 uploads the SMIL file from the web browser 108 and generates a corresponding HTML file.

Specifically, in the web server 140, the SMIL upload unit 142 prepares a web page for providing an upload service so that the user can upload a desired SMIL file and the SMIL file is uploaded from the web browser 108 through the web page. Generally, the user is a member who has already completed a predetermined subscription procedure.

However, it is understood that the user need not be a subscriber in all circumstances.

The HTML generating unit 144 generates an HTML file corresponding to the SMIL file. The HTML file is generated so that the user can access the uploaded SMIL file on the web page through the web browser 182. The uploaded SMIL and the corresponding HTML file are stored in the file database 150 organized by member.

The file information display unit 146 directly displays the HTML file generated through the HTML generating unit 144, or displays an HTML file edited in various ways either by member or by a predetermined category, referring to the file DB 150. The user order processing unit 148 receives an order for the corresponding SMIL file when a user accesses through a web browser 182 the HTML file displayed on the web page. Here, the user can be the user who registered the SMIL file or any other user.

The streaming server 160 provides a streaming service after searching the file DB 150 when a user requests the streaming service of the SMIL file through the user order processing unit 148. The streaming service is a service which enables a medium file to be played after downloading relatively smaller pieces of data piece-by-piece using a special compression technology in order to overcome the limitation due to the high capacity of the existing medium file.

Meanwhile, when a user requests a mail server 170 of an SMIL file through the user order processing unit 148, the mail server 170 sends an electronic message attaching the corresponding HTML file, to the other location specified by the user. Then, the mail recipient receives the streaming service for the SMIL file by accessing the HTML file in the received mail. It is further understood that the electronic message can include a hypertext link to the HTML file instead of attaching the HTML file in an attachment.

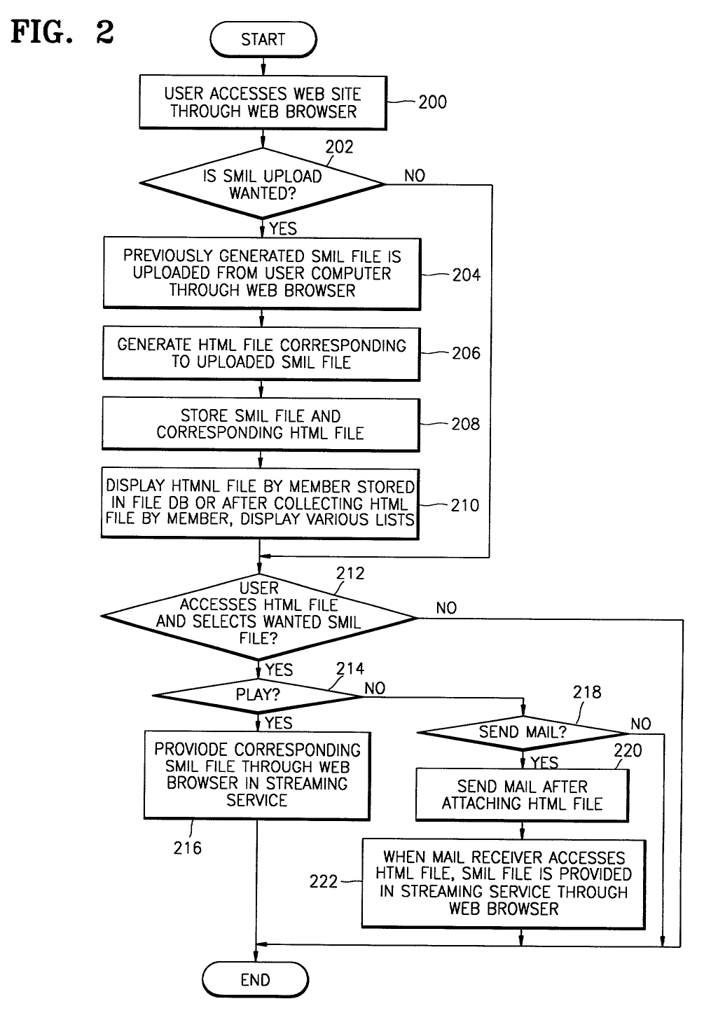

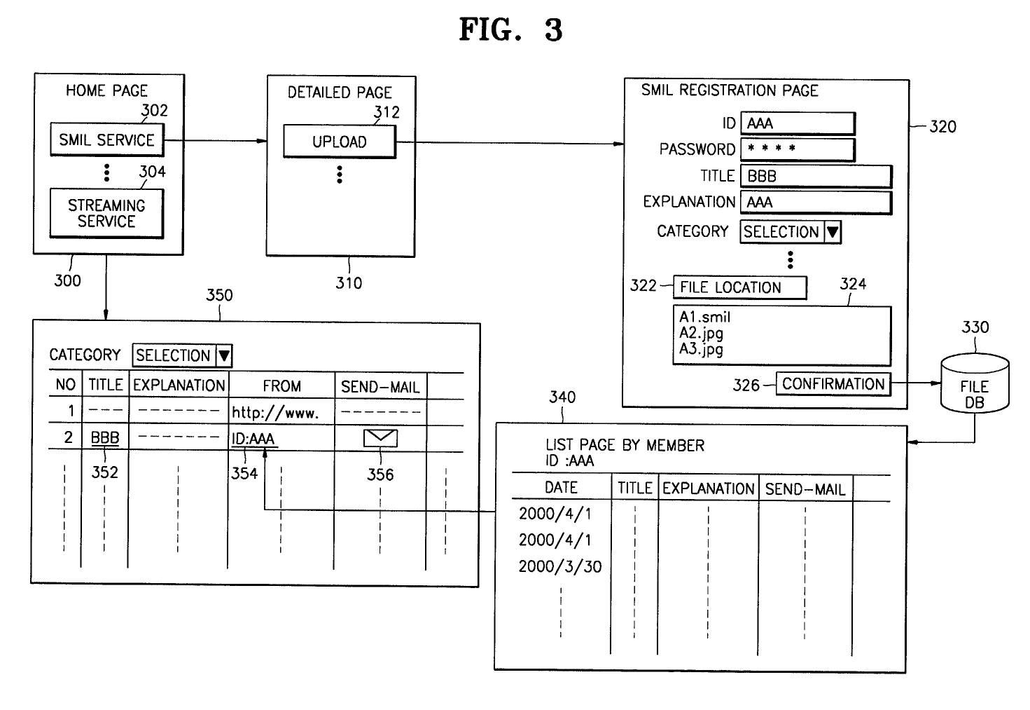

FIG. 2 is a flowchart for explaining an EMD service method according to the present invention, and FIG. 3 illustrates an example of web pages included in a web site providing an EMD service according to the present invention.

Referring to FIGS. 2 and 3, the EMD service method will now be explained in detail. First, a user accesses a web site through the web browser in operation 200. For example, the user accesses the home page 300 shown in FIG. 3. The home page 300 includes an SMIL service part 302 and a streaming service part 304. Generally, in order to receive service parts included in the home page 300, a user is a member already registered with the web site 300. However, this is not required in all circumstances.

After the user accesses the web site, it is determined whether or not the user wants to upload an SMIL file in operation 202. For example, it is determined whether or not the SMIL service part 302 of the home page 300 in FIG. 3 is selected. When an upload is wanted, an SMIL file, which has been generated by the user, is uploaded from the user computer through the web browser in operation 204. An HTML file corresponding to the uploaded SMIL file is generated in operation 206.

For example, when the user selects the SMIL service part 302 of the home page 300 in FIG. 3, the linked detailed page 310 is displayed through the web browser, and when the upload 312 is selected, the registration page 320 on the SMIL file is displayed. Specifically, through the registration page 320 on the SMIL file, for example, through the file location 322, the user uploads the SMIL file and related graphic file and text file stored in the user computer as shown in input contents 324. Also, the user inputs user information (for example, ID, password), the title of the SMIL file, a brief explanation, a category, etc., which are required for generating an HTML file.

After the operation 206, the SMIL file and the corresponding HTML file are stored in the file DB in operation 208. For example, when the user selects the confirmation button 326 in FIG. 3, the input contents are stored in the file DB 330. The HTML files, which are stored organized by member in the file DB, are displayed by member or in various lists, after collecting HTML files by member, in operation 210. For example, the list page by member 340 in FIG. 3 shows information on SMIL files, which a user has uploaded so far.

After the operation 210 or operation 202, it is determined whether the user has accessed the HTML file through the web browser and selected an SMIL file in operation 212. Here, the user is a user who has previously uploaded the SMIL file, or any other user. For example, when the streaming service part 304 is selected in the home page 300 in FIG. 3, the list page on the SMIL files 350 is displayed through the web browser. Reading the titles of the SMIL files, the user can select a desired SMIL file.

Next, it is determined whether or not the user wants to select and play a desired SMIL file in operation 214. When play is selected, the corresponding SMIL file is provided in a streaming service through the web browser in operation 216. Meanwhile, when the user selects a wanted SMIL file and wants to send mail in operation 218, an E-mail attaching the corresponding HTML file is sent to a location designated by the user in operation 220. Then, when the mail receiver accesses the HTML file, the SMIL file is provided in a streaming service through the web browser in operation 222. It is understood that the HTML file need not be attached to the mail, but instead an HTML link to the HTML file may be included in the mail.

For example, as shown in FIG. 3, when a user selects the title 352 of an SMIL file in the web page 350, which classifies the HTML file, corresponding to the registered SMIL file in the form of a predetermined list, operation 216 is performed. However, if the send-mail 356 is selected, operation 220 is performed. In addition, when the ID 354, with which the SMIL file is registered, is selected, the list page organized by member the 340 is accessed.

It is understood that the EMD service and web pages shown are examples and the present invention is not limited to these examples.

Also, the present invention was explained with the EMD service under an environment linked to the internet. However, it is understood that this environmental condition is just an example of an application, and that the present invention can be applied through various networks such as an optical cable network, a wireless internet, a mobile communication network, PC communication network, etc.

Further, the present invention was explained with a user computer as an example, but diverse user terminals, such as an internet phone, a personal data assistant (PDA), and a mobile communication terminal which a user can carry, can be used. In addition, it is understood that additional forms of electronic messages can be sent in addition to or instead of e-mail where the message is sent digitally to an address.

As described above, the present invention enables a user to easily let others access an SMIL file, which the user directly authors, and by providing the SMIL file in a streaming service, the present invention fills the users' need, which has not been filled with the existing music. The present invention also enables a user to make and play the user's own digital album through a network.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic music distribution (EMD) service system in a network environment, the EMD service system comprising:
a web server to upload a multimedia file that is in a synchronous multimedia integration language (SMIL) format, from an uploading web browser of a user terminal linked to the network, to generate a hyper text markup language (HTML) file corresponding to the multimedia file, and to display the HTML file so that an accessing user can access the HTML file through an accessing web browser;
a file database to store the uploaded multimedia file and the corresponding HTML file; and
a streaming server to search the file database for the multimedia file requested by the accessing web browser linked to the web page, and to provide the multimedia file in a streaming service.

2. The EMD service system of claim 1, wherein said web server comprises:
an uploading unit to upload the multimedia file from the web browser;
an HTML generating unit to generate the HTML file corresponding to the multimedia file;
a file information display unit to display the HTML file, which is organized by each member, in the form of a predetermined web page; and
a user order processing unit to receive an order for the corresponding multimedia file when the accessing user accesses the HTML file on the web page through the accessing web browser.

3. The EMD service system of claim 1, further comprising a mail server to send the HTML file corresponding to the multimedia file, which is requested from the accessing web browser linked to the web page, in an E-mail.

4. A multimedia file service method in an electronic music distribution (EMD) service system, the multimedia file service method comprising:
uploading a multimedia file, which was generated in a user terminal in a synchronous multimedia integration language (SMIL) format, from an uploading web browser of the user terminal;
generating a hyper text markup language (HTML) file corresponding to the uploaded multimedia file, and storing the HTML file in a file database with other HTML files; and
displaying the HTML file and/or other HTML files stored in the file database in the form of a web page so that a user can access the HTML files through an accessing web browser.

5. The multimedia file service method of claim 4, wherein said displaying the HTML files comprises displaying the HTML file, which is generated for each member, on a web page for each member.

6. The multimedia file service method of claim 4, wherein said displaying the HTML files comprises displaying a web page, which classifies the HTML files in the form of various lists after collecting the HTML files generated for each member.

7. A streaming service method in an electronic music distribution (EMD) system for a multimedia file generated using a synchronous multimedia integration language (SMIL) format, the streaming service method comprising:
displaying file information in the form of a web page, referring to a file database which stores the multimedia file and a corresponding hyper text markup language (HTML) file;
determining whether an accessing user accesses the HTML file on the web page through a web browser and selects a multimedia file to play; and
when the user selects the multimedia file to play, searching the file database and providing the corresponding multimedia file in a streaming service.

8. The streaming service method of claim 7, wherein the multimedia file was generated in a user terminal and uploaded through a network.

9. A mail service method in an electronic music distribution (EMD) system for a multimedia file generated using a synchronous multimedia integration language (SMIL) format, the mail service method comprising:
displaying file information in the form of a web page, referring to a file database storing the multimedia file and a corresponding hyper text markup language (HTML) file;
determining whether a user accesses the HTML file on the web page through a web browser and selects to send an E-mail including the multimedia file; and
when the user wants to send the E-mail, sending the E-mail to a location designated by the user, after attaching the corresponding HTML file.

10. The mail service method of claim 9, wherein the multimedia file is generated in a terminal of the user and uploaded through a network.

11. The mail service method of claim 9, wherein after the E-mail is sent, the receiver of the E-mail accesses the attached corresponding HTML file and receives a service for the corresponding multimedia file through a web browser of the receiver.

12. A computer readable medium encoded with processing instructions for implementing a computer implemented method of creating a digital album on a web server, the method comprising:
displaying a registration web page at the request of a web browser;
uploading an identified multimedia file formatted in a synchronous multimedia integration language (SMIL) format from a user terminal at the request of the web browser accessing the registration web page;
generating a digital album web page that incorporates the identified multimedia file; and
displaying the digital album web page at the request of the same or another web browser.

13. The computer readable medium of claim 12, further comprising storing the digital album web page in a database.

14. The computer readable medium of claim 13, wherein said generating the digital album comprises generating a hyper text markup language (HTML) file referencing the uploaded multimedia file and/or multimedia files uploaded by a user.

15. The computer readable medium of claim 14, wherein the database stores other HTML files referencing the uploaded multimedia files of other users in addition to the HTML file for the user, and where the computer readable medium further comprises generating an index HTML file at the request of the same or another web browser, where the index HTML file classifies the uploaded multimedia file and/or any other multimedia files of the same and/or another user in the form of a list.

16. The computer readable medium of claim 15, wherein the index HTML file lists the uploaded multimedia file and/or any other multimedia files according to the users who uploaded the corresponding multimedia file.

17. The computer readable medium of claim 15, wherein said uploading further comprises receiving descriptive data for the uploaded multimedia file, and wherein the index HTML file lists the uploaded multimedia file and any other multimedia files according to the descriptive data for the corresponding multimedia file.

18. The computer readable medium of claim 15, further comprising:
receiving a request to play a selected multimedia file from the same or another web browser, where the selected multimedia file is incorporated on the displayed digital album web page; and
playing the selected multimedia file using a streaming service.

19. The computer readable medium of claim 15, further comprising
receiving a request to send an electronic message referencing a selected multimedia file from the same or another web browser, where the selected multimedia file is incorporated on the displayed digital album web page; and
sending the electronic message referencing the selected multimedia file using a streaming service.
